(19) United States
(12) Patent Application Publication
(10) Pub. No.: US 2024/0131743 A1
(43) Pub. Date: Apr. 25, 2024

(54) TOOLS FOR CUTTING AND SANDING SOLID MATERIALS

(71) Applicant: Zachary Smith, Sand Springs, OK (US)

(72) Inventor: Zachary Smith, Sand Springs, OK (US)

(21) Appl. No.: 18/396,729

(22) Filed: Dec. 27, 2023

Related U.S. Application Data
(63) Continuation-in-part of application No. 17/668,357, filed on Feb. 9, 2022.
(60) Provisional application No. 63/184,511, filed on May 5, 2021.

(51) Int. Cl. B26D 7/27

(52) U.S. Cl. CPC B26D 7/27

(57) ABSTRACT

A tool, such as blades and drill bits to be used with cutting devices for cutting through solid material and simultaneously sanding the solid material. The tool includes a body having an attachment point for the cutting devices. Teeth are disposed along a length of a periphery of the body for cutting the solid and sanding layer disposed over an exposed outer surface of the body for sanding new surfaces in the solid material created upon cutting by the cutting devices.

### CROSS-REFERENCE TO RELATED APPLICATIONS

This application is a continuation-in-part of a U.S. patent application Ser. No. 17/668,357 filed on Feb. 9, 2022, which claims priority from a U.S. Patent Appl. No. 63/184,511, filed on May 5, 2021, which is incorporated herein by reference in its entirety.

### FIELD OF INVENTION

The present invention relates to a tool for cutting and sanding solid materials, and more particularly, the present invention relates to a tool for cutting through solid material and simultaneously sanding the cut surfaces.

### BACKGROUND

Tools, such as blades, drill bits, and the like are used to cut solid material, often wood but also metal, concrete, ceramic, and the like. The tools are used with hand-operated or electrically powered devices, such as a hand saw, electrical saw, drill machine, and the like. For example, a saw blade in an electric saw for cutting through wood.

Cutting through a solid material creates new surfaces and such new surfaces often need sanding for a smooth surface. The process of smoothing a new surface is referred to as a finishing step. Typically, hand operated or electrically powered sanders are available for smoothening a surface. However, the sanding step is tedious and time-consuming.

A need is always there to improve existing processes and tools for more efficiency. A need is therefore appreciated for a device that can make the job of cutting and sanding solid material easier and quick.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a tool for cutting through solid materials and simultaneously smoothening the newly created surfaces.

It is another object of the present invention that the additional step and tool of sanding after the cutting is eliminated.

It is still another object of the present invention that the time for smoothing a surface is saved.

It is yet another object of the present invention to allow completing a job faster and with lesser effort.

In one aspect, disclosed is a tool for cutting through a solid material, the tool comprising a body, the body has an attachment point for a device, the body has an exposed outer surface and a periphery; teeth disposed along a length of the periphery, the teeth configured to cut through the solid material creating new surfaces; and abrasives disposed over the exposed outer surface, wherein the abrasives are configured to sand the new surfaces.

In one implementation of the tool, the tool is a round saw blade, the body is a planar body, the abrasives are disposed on both sides of the planar body, and the teeth are along the periphery of the planar body.

In one implementation of the tool, the tool is an elongated blade, the elongated blade has a planar body having a top periphery and a bottom periphery, the teeth are along a length of the bottom periphery, the abrasives are disposed on opposite sides of the planar body.

In one implementation of the tool, the tool is a drill bit, the drill bit has a cylindrical body, the teeth are disposed along a bottom periphery of the cylindrical body, the abrasives are disposed over the outer exposed surface of the cylindrical body.

In one implementation of the tool, the teeth and the outer exposed surface are aligned along a common plane. The solid material is wood. The solid material is metal, and the abrasives are disposed in a crosshatch pattern. The device is an electrical saw, hand saw, or a drill machine.

In one aspect, disclosed is a device for cutting through a solid material and simultaneously sanding the solid material, the device comprises a tool for cutting through solid material. The tool comprising a body, the body has an attachment point for the device, the body has an exposed outer surface and a periphery; teeth disposed along a length of the periphery, the teeth configured to cut through the solid material creating new surfaces; and abrasives disposed over the exposed outer surface, wherein the abrasives are configured to sand the new surfaces.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 shows a saw blade as a tool having a layer of abrasives on both the planar sides of the saw blade and teeth along a periphery of the saw blade, according to an exemplary embodiment of the present invention.

FIG. 2 shows a wood drill bit having a cylindrical body, teeth along a periphery of the cylindrical body, and a layer of abrasives on an exposed outer surface of the cylindrical body, according to an exemplary embodiment of the present invention.

FIG. 3 shows a hand saw with the blade as the tool, the blade has teeth at one edge along the length of the blade, and layers of abrasives on opposite planar sides of the blade, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

Disclosed is a tool that can be used for cutting through solid material and simultaneously sanding the newly created surfaces in the solid material. The solid material can be wood or metal. The tool can be implemented in the form of blades, drill bits, and the like. The tools can be used in hand-operated or electric-powered devices, such as a hand saw, an electric saw, a hand drill machine, and a power drill machine.

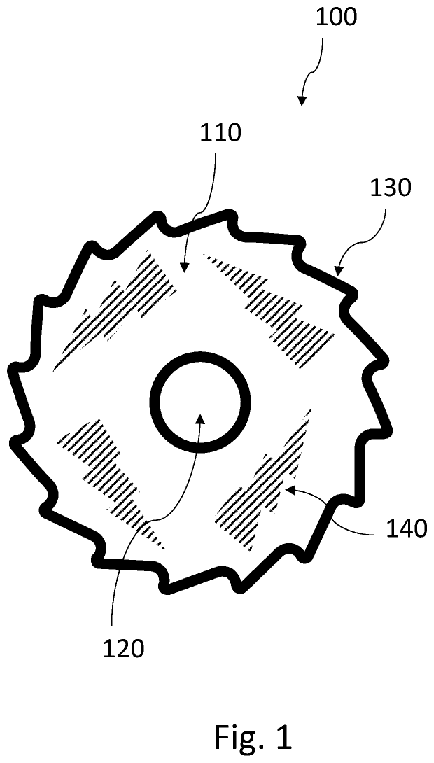

Referring to FIG. 1, which illustrates an exemplary embodiment of the tool 100 implemented as a round saw blade. The tool 100 can include a planar body 110 made from a strong material, such as but not limited to, steel. The planar body 110 can have an aperture 120 at a center for engaging the tool 100 to a device such as an electric saw. The planar body 110 has two opposite sides, i.e., a left side and a right side, only one side is visible in the drawing. Along a periphery of the planar body 110 are the cutting teeth 130. On one or both sides of the planar body 110 can be disposed a layer of abrasives 140, in a predetermined pattern. The choice of abrasives may depend upon the material to be cut, such as different abrasives can be for wood and metal. The structure and functioning of the abrasives for sanding different solid materials are known to a skilled person, and any such known abrasives are within the scope of the present invention. For example, a crosshatch on the planar body can be provided for metal cutting tools, wherein the crosshatch can smoothen the newly created metal surfaces. The abrasives can be bonded to the exposed surfaces of the tool other than the cutting surfaces. Alternatively, the abrasives can be integral with the planar body forming a single unit. For example, the abrasives in a predetermined pattern can be bonded using adhesives by suitable treatment. The predetermined pattern may depend upon the cutting pattern, the solid material to be cut, and the movement of the tool while cutting through the solid material. It is understood, however, that certain embodiments have been described for the tool 100 as an exemplary embodiment, however, the described aspects of the invention are applicable to other embodiments as well without any limitation.

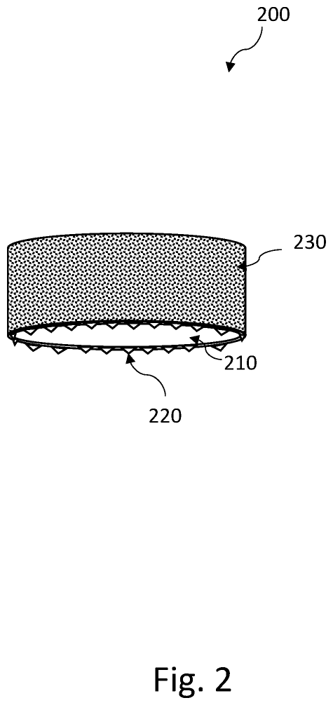

Referring to FIG. 2, which shows another exemplary embodiment of the tool 200 implemented as a drill bit for cutting through wood. The tool 200 has a cylindrical body 210, wherein the diameter of the cylindrical body can be proportional to the diameter of a hole that has to be made in the wood using the tool 200. A bottom periphery of the cylindrical body 210 can have teeth 220 extending along a circumference of the cylindrical body 210. On the exposed outer surface of the cylindrical body 210 can be seen a layer of abrasives 230 for smoothing a wood surface.

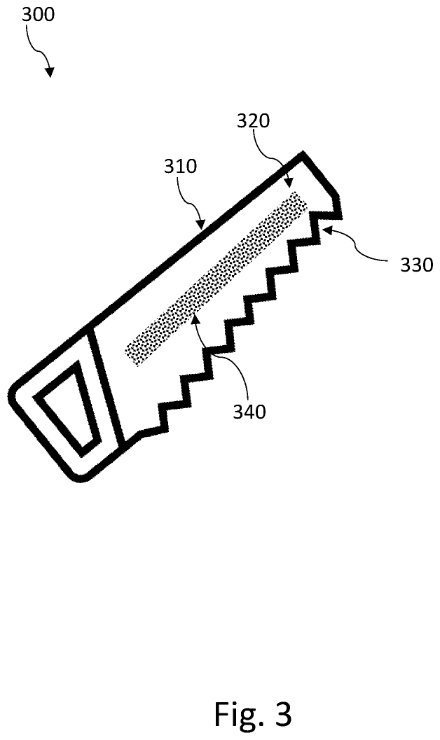

Referring to FIG. 3 which shows an exemplary embodiment of a hand saw 300 that includes an elongated blade 310 as an implementation of the disclosed tool. The elongated blade 310 can be used for cutting through wood. The elongated blade 310 can have a planar body 320 of an elongated geometry having a top edge and a bottom edge. The bottom edge can have teeth 330 along a length of the planar body 320, the teeth can be for cutting through the wood. The structure, functioning, and arrangement of teeth in a hand saw blade is known to a skilled person. On either of the body sides of the planar body can be provided a layer of abrasives 340 in a predetermined pattern.

The abrasive layer is disposed as a very thin layer so as to only smoothen the newly created surfaces. The abrasive layer does not cut the material but only sands the new created surfaces. For example, the thickness of the abrasive layer, also referred to herein as the sanding layer can be about 2-2.6 mm. Moreover, the size of the abrasive materials or protrusion can correspond to 60-400 grit scale of a standard sanding paper.

The abrasive layer can be disposed in a variety of patterns, such as crosshatch pattern. The abrasive layer may include pointed conical protrusion arranged on the crosshatch pattern.

The abrasive material can be a combined mixture of adhesive and various products. Products used can be, but not limited to, sand, silica sand, and diamond dust. The application process begins with using solvents, then adhesion or bonding agents, then the applied light layer of adhesion. Then a mixture of abrasive material and adhesion products can be applied to meet the specification of the desired thickness of the cutting edge to allow a smooth finish. Another example, is the invention can also be used in a sanding only situation, if desired. Essentially making it 2 tools in 1.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A tool for cutting through a solid material, the tool comprising:
a body, the body has an attachment point for a device, the body has an exposed outer surface and a periphery;
teeth disposed along a length of the periphery, the teeth configured to cut through the solid material creating new surfaces; and
a sanding layer disposed over the exposed outer surface, wherein the sanding layer is configured to sand and smooth the new surfaces, wherein the sanding layer is of a thickness ranging from 2-2.6 mm.

2. The tool according to claim 1, wherein the tool is a round saw blade, the body is a planar body, the sanding layer is disposed on both sides of the planar body, and the teeth are along a periphery of the planar body.

3. The tool according to claim 1, wherein the tool is an elongate blade, the elongate blade has a planar body having a top periphery and a bottom periphery, the teeth are along a length of the bottom periphery, the sanding layer is disposed on opposite sides of the planar body.

4. The tool according to claim 1, wherein the tool is a drill bit, the drill bit has a cylindrical body, the teeth are disposed along a bottom periphery of the cylindrical body, the sanding layer is disposed over the outer exposed surface of the cylindrical body.

5. The tool according to claim 1, wherein the teeth and the outer exposed surface are aligned along a common plane.

6. The tool according to claim 1, wherein the solid material is wood.

7. The tool according to claim 1, wherein the solid material is metal, the sanding layer comprises abrasives disposed in a crosshatch pattern.

8. The tool according to claim 1, wherein the device is an electrical saw, hand saw, or a drill machine.

9. A device for cutting through a solid material and simultaneously sanding the solid material, the device comprises:
a tool for cutting through solid material, the tool comprising:
a body, the body has an attachment point for a device, the body has an exposed outer surface and a periphery;
teeth disposed along a length of the periphery, the teeth configured to cut through the solid material creating new surfaces; and
a sanding layer disposed over the exposed outer surface, wherein the sanding layer is configured to sand and smooth the new surfaces, wherein the sanding layer is of a thickness ranging from 2-2.6 mm.

10. The device according to claim 9, wherein the tool is a round saw blade, the body is a planar body, the sanding layer is disposed on both sides of the planar body, and the teeth are along a periphery of the planar body.

11. The device according to claim 9, wherein the tool is an elongate blade, the elongate blade has a planar body having a top periphery and a bottom periphery, the teeth are along a length of the bottom periphery, the sanding layer is disposed on opposite sides of the planar body.

12. The device according to claim 9, wherein the tool is a drill bit, the drill bit has a cylindrical body, the teeth are disposed along a bottom periphery of the cylindrical body, the sanding layer is disposed over the outer exposed surface of the cylindrical body.

13. The device according to claim 9, wherein the teeth and the outer exposed surface are aligned along a common plane.

14. The device according to claim 9, wherein the solid material is wood.

15. The device according to claim 9, wherein the solid material is metal, the sanding layer comprises abrasives disposed in a crosshatch pattern.

16. The device according to claim 9, wherein the device is an electrical saw, hand saw, or a drill machine
